(19) United States
(12) Patent Application Publication
(10) Pub. No.: US 2002/0087559 A1
(43) Pub. Date: Jul. 4, 2002

(54) METHOD AND SYSTEM FOR RETRIEVING DOCUMENTS USING HYPERLINKS

(76) Inventor: JOHN PRATT, ATKINSON, NH (US)

Correspondence Address: Mary Lou Wakimura, Hamilton Brook Smith & Reynolds P C, 2 Militia Drive, Lexington, MA, 02421, US

(21) Appl. No.: 09/228,352

(22) Filed: Jan. 11, 1999

(51) Int. Cl. G06F 7/00

(52) U.S. Cl. 707/100

(57) ABSTRACT

A method and apparatus for providing content to a user via a network are described. A server system receives a request from a client node to obtain digital information (e.g., a document). The request includes a resource locator, e.g., a Uniform Resource Locator (URL), specifying the digital information to obtain from a storage system. In response to the resource locator, the storage system communicates with the storage system, causing a file containing a copy of the specified digital information to be dynamically generated and stored at an address location in memory. The server system redirects the client request to this address location, via a new, dynamically generated resource locator, accesses the file to obtain a copy of the specified digital information, and transmits the copy of the specified digital information over the network to the client node.

### FIELD OF THE INVENTION

The invention relates generally to the field of computer communications between computer nodes over a network. More specifically, the invention relates to the field of digital information retrieval by a client node from a server node using hyperlinks.

### BACKGROUND

The Internet is an international collection of interconnected networks currently providing connectivity among millions of computer systems. One part of the Internet is the World Wide Web (“Web”), a graphics and sound-oriented technology used by computer systems (clients) to access a vast variety of digital information, e.g., files, documents, images, and sounds, stored on other computer systems, called “Web sites” (or “Web servers”). A Web site consists of electronic pages or documents called “Web pages.”

Client system users can view digital information at Web sites through a graphical user interface produced by executing client software called a “browser.” Examples of commercially available Web browsers include Netscape Navigator™ and Microsoft Internet Explorer™. Web browsers use a variety of standardized methods (i.e., protocols) for addressing and communicating with Web servers. A common protocol for publishing and viewing linked text documents is HyperText Transfer Protocol (HTTP).

To access a Web page at a Web server, the client system user enters the address of the Web page, called a Uniform Resource Locator (URL), in an address box provided by the Web browser. The URL can specify the location of a file on a Web server. A URL includes several parts, delineated by combinations of the “/” and “:” characters. The first part provides protocol information, such as http or ftp (file transfer protocol). Other protocols can be used. Domain information typically follows the protocol information. The domain information is a group of Web servers having centrally administered security. Typically following the domain information is the Web server location and the name of a file. An accessed Web page can include any combination of text, graphics, audio, and video information (e.g., images, motion pictures, animation, etc.). Often, the accessed Web page has links, called hyperlinks, to documents at other Web pages on the Web.

A hyperlink can be a highlighted (e.g., colored) and/or underlined text, or a graphic that activates a URL for downloading and opening another Web page or some form of multimedia content, such as a picture or sound file. To navigate to the other Web page or multimedia content, a client user selects the hyperlink, e.g., by clicking on the underlined text or graphic with a mouse.

HyperText Markup Language (HTML) is the standard computer language used to format documents for publishing as Web pages. Web page designers can insert HTML “tags,” called anchors, into documents to create the hyperlinks. Tags instruct the Web browser on how to format the document when displaying the document on the client screen. An anchor with an HREF attribute jumps to a file outside the current document. For example, the following anchor creates a hyperlink that jumps to a particular Web page (called Home Page) on the “my_domain” host server:

<A HREF=“http://www.my_domaim.com/default.htm”>Home Page</A>

Accordingly, HTML and hyperlinks provide a mechanism for accessing documents published on the Web. However, such hyperlinks link to static content, and therefore unless the documents are stored as files on a Web Server, HTML cannot provide direct access to those documents. This can be problematic for documents that do not exist on a Web server, such as managed documents stored in a repository remote from the Web. Generally, before a client user can view a document stored in the repository, that document is duplicated on a Web server so that a hyperlink can point directly to that document. Changes, however, to the original version stored in the repository are not reflected in the duplicate version on the Web server, and the client user can remain unaware such changes. Subsequent selections of the document by the client user may retrieve the out-dated duplicate version because the associated hyperlink still points to the out-dated version on the Web server.

### SUMMARY

In one aspect, the invention features a method for providing content to a user via a network. A server system receives from a client node a request to obtain content. The request includes a first resource locator specifying the digital information to be obtained. The specified digital information can be obtained from a storage system. A file containing a copy of the specified digital information is dynamically generated in response to the first resource locator and stored at an address location in memory. The file is then accessed at the address location with a second resource locator different from the first resource locator to obtain the specified digital information for transmission over the network to the client node. The file can be stored at another computer system other than at the server system. The storage system can include a document management system.

The first resource locator can lead to a document containing content that can change dynamically. Also, the first resource locator can include a document identifier that is transmitted to the storage system. The specified digital information can be extracted from the storage system in response to the document identifier. The server system can have an executable program that communicates with the storage system in response to the first resource locator. The executable program can be dynamically generated in response to a query to find digital information according to one or more search terms specified by a user of the client node. A page containing results of the query can be dynamically generated. The page can include at least one hyperlink. Each hyperlink can be associated with a document found according to the specified search terms and can point to the executable program at the server system. This page can be transmitted over the network to the client node.

In another aspect, the invention features a hyperlink notation for obtaining content over a network. The notation includes a first resource locator. The first resource locator has protocol information, server information indicating an address of a server located on the network, a server page that references an executable program located on the server, and content identification information specifying digital information to be obtained from a storage system. The program, when executed, communicates with the storage system using objects designed specially to dynamically generate a file containing a copy of the specified digital information and to store the file at an address location in memory. A second resource locator can be used to reference the address location of the file. The first resource locator can redirect to the second resource locator for downloading the digital information in the file directly to the browser via a web server. The content identification information can include a document identifier specifying the digital information to be obtained from the storage system. The content identification information can follow the program information.

### BRIEF DESCRIPTION OF THE DRAWINGS

The invention is pointed out with particularity in the appended claims. The above and further advantages of the invention may be better understood by referring to the following description in conjunction with the accompanying drawings, in which:

FIG. 1 is a diagram of an embodiment of a client computer system in communication with a server computer system for obtaining content over a network in accordance with the invention;

FIG. 2 is a block diagram illustrating a communication sequence between the client node and the server for conducting a document search;

FIG. 3A is a diagram of a conventional hyperlink including protocol information, host server information, and resource information;

FIG. 3B is a diagram of a hyperlink of the invention including protocol information, host server information, active server page information, and content identification information, which relates to a first resource locator;

FIG. 3C is a diagram of a second resource locator redirected to from the first resource locator according to the invention;

FIG. 4 is an exemplary Web page displaying the results of a document search including three hyperlinks representing three documents found in a storage system satisfying the specified search terms;

FIG. 5 is a flow chart representation of an exemplary process for conducting a document search; and

FIG. 6 is a block diagram representation of a communication sequence between the client node and the server for obtaining one of the documents found by the document search.

### DESCRIPTION OF THE INVENTION

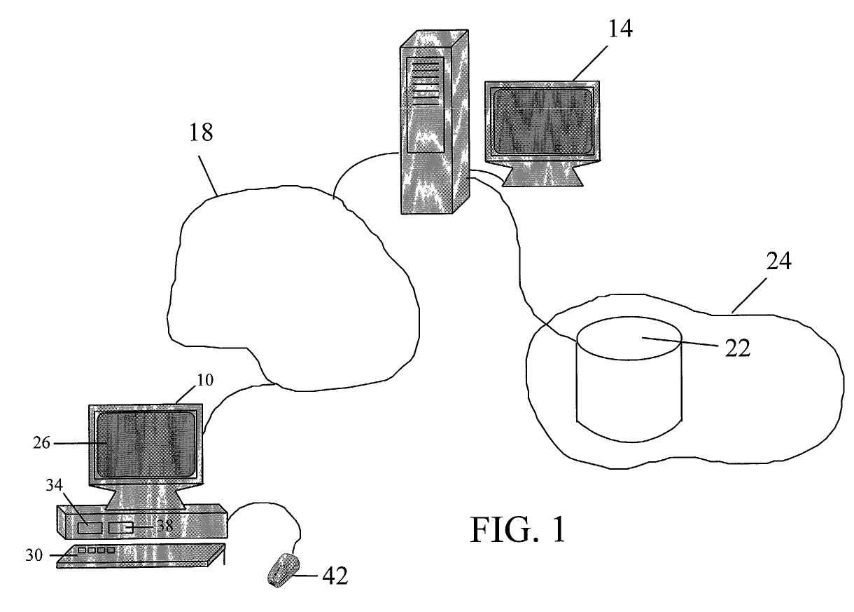

FIG. 1 shows a first computing system (client node) 10 in communication with a computing system (server) 14 via a first network 18. The server 14 is in communication with a storage system 22 providing storage for digital information representing documents, files, graphical images, audio data, video data, etc. The storage system 22 can be on a second network 24 unconnected to the first network 18, except through the server 14. The second network 24 can be, for example, an Intranet to which the client node 10 does not have direct access, and the digital information stored in the storage system 22 may not be directly addressable by the client node 10. It is to be understood that more or fewer client nodes, servers, and storage systems than those shown can be connected to the networks 18, 24.

The network 18 can be a local-area network (LAN), an Intranet, or a wide area network (WAN) such as the Internet or the World Wide Web. A user of the client node 10 can be connected to the network 18 through a variety of connections including standard telephone lines, LAN or WAN links (e.g., T1, T3, 56 kb, X.25), broadband connections (ISDN, Frame Relay, ATM), and wireless connections. The connections can be established using a variety of communication protocols (e.g., HTTP, TCP/IP, IPX, SPX, NetBIOS, Ethernet, RS232, and direct asynchronous connections).

The client node 10 can be any personal computer (e.g., 286, 386, 486, Pentium, Pentium II), thin-client device, Macintosh computer, Windows-based terminal, Network Computer, wireless device, information appliance, RISC Power PC, X-device, workstation, mini computer, main frame computer, or other computing device that has a graphical user interface. Windows-oriented platforms supported by the client node 10 can include Windows 3.x, Windows 95, Windows 98, Windows NT 3.51, Windows NT 4.0, Windows CE, Windows CE for Windows Based Terminals, Macintosh, Java, and Unix.

The client node 10 can include a display screen 26, a keyboard 30, memory 34, a processor 38, and a mouse 42. Application programs can execute locally at the client node 10 (i.e., client-based execution) or at the server 14 (i.e., server-based execution). For server-based execution, the graphical user interface, keystroke, and mouse movements are transmitted over the network 18 from the server 14 to the client node 10. One such application program is browser software, e.g., Netscape Navigator™ or Microsoft Internet Explorer™.

The server 14 can be any computing system that can operate as a Web server, communicate according to the HTTP protocol, maintain Web pages, process URLs, and control access to other portions of the network 18 (e.g., workstations, storage systems, printers) or to other networks such as the Intranet 24. In one embodiment, the server 14 is an Microsoft® Internet Information Server (IIS) running under Windows NT. The IIS includes a programming interface called Internet Server API (ISAPI). Web pages on the server 14 can invoke DLL programs on the server 14 using ISAPI function calls. A typical use of ISAPI calls is to access digital information stored in a database.

The storage system 22 can be any of a variety of systems that maintains digital information including, for example, a database server, a file storage system having large binary files, a legacy mini-computer or main-frame computer with storage. The digital information stored by the storage system 22 may be static (i.e., unchanging) or dynamic (i.e., changing). The storage system 22 may or may not be outside of the Web environment of the network 18, that is, unconnected to the network 18, except through the server 14. An advantage of such a remote storage system 22 is that users connected to the network 18 cannot gain unauthorized access to and compromise the integrity of the stored digital information.

In one embodiment, the storage system 22 includes a document management system such as, for example, the Document Manager for Microsoft® Exchange® (DMX™) produced by Eastman Software. Generally, a document management system includes software that manages documents for electronic publishing on LANs and WANs, supporting a variety of document formats and providing access control and searching capabilities. The document management system can track and maintain versions of documents. Often, the document management system can include a workflow component that routes documents to appropriate users for review and/or modification. Content within documents managed by the storage system 22 can change dynamically.

To communicate with the server 14, the client node 10 typically launches the browser program and connects to the server 14 by specifying a resource locator corresponding to the server 14. Throughout the description the resource locator is specifically referred to as a Uniform Resource Locator (URL), but any type of address scheme that defines a path to a resource on the network 18 can be used to practice the principles of the invention.

Upon connection, the browser can then display an introductory Web page and prompt the user to log on by supplying a username and a password. Proper response by the client user can establish an authenticated session between the browser and the server 14. Such authentication can be required before the client user is granted access to digital information stored in the storage system 22. Accordingly, the server 14 can operate as an interface between the network 18 and the storage system 22.

The browser can then request digital information from the server 14 using URLs that, according to the principles of the invention, contain information that directs the server 14 to obtain the digital information from the storage system 22. The resource path specified in the URL, on its face, provides no indication to the client user of the actual source of the digital information. Hyperlinks directed to such URLs appear to point to the server 14. Neither the client user nor the browser software may be aware that the server 14 obtains the information from another source. Such hyperlinks, in effect, hide the existence of the storage system 22, but take advantage of the information stored therein. Client users are able to query against digital information stored in repositories remote from the network 18 and unknown to the client node 10.

As described in more detail below, the server 14 processes the URL to extract a copy of the requested digital information from the storage system 22. The extracted digital information is stored in a temporary file. The server 14 redirects to an ISAPI DLL passing the name of the temporary file. The ISAPI DLL reads the file, formatting the read digital information into an HTML document (or HTML page), and returning the HTML document to the client node 10 via the server 14. The browser translates the HTML document with any accompanying graphics files and applets and displays the results on the client screen 26.

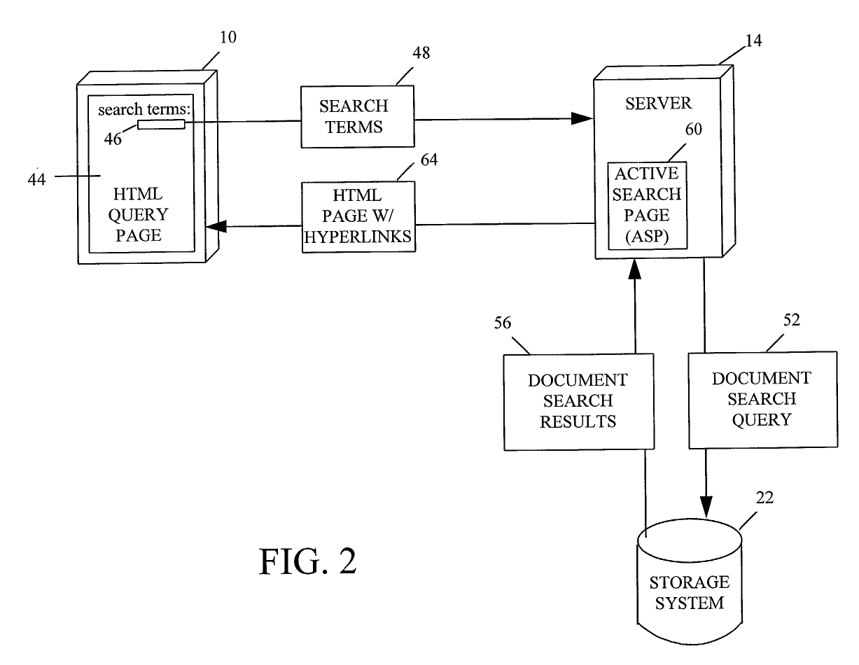

FIG. 2 shows an exemplary communication sequence between the client node 10 and the server 14 for conducting a document search. An HTML query page 44 appears on the screen 26 of the client node 10. The HTML query page 44 includes a search term box 46 for receiving user-specified search terms 48. To enter the search terms 48, the user can click upon the box with the mouse 42 and type in the terms via the keyboard 30.

When submitted by the client user, the search terms 48 are appended to the URL and passed to the server 14. The server 14 submits a document search query 52 to the storage system 22 using the search terms 48 as search parameters. The search parameters include objects understood by the storage system 22 as instructions to perform the search. The storage system 22 performs the requested search and returns the search results 56 to the server 14. Typically, the search results 56 include a list of documents found to satisfy the search parameters.

In response to the search results 56, the server 14 dynamically generates an active server page 60. The active server page 60 is executable software, e.g., a Common Gateway Interface (CGI) scripts or Dynamic Link Libraries (DLL), that maintains a document identifier for each found document. The active server page 60 is designed to communicate with the storage system 22, through the passing of parameters and objects, to obtain any of the found documents when so requested.

The server 14 also produces an HTML results page 64 corresponding to the list of found documents, and transmits the HTML results page 64 to the client node 10 for display. Embedded in the HTML page 64 are hyperlinks associated with the found documents. Such hyperlinks may be considered “virtual” hyperlinks because these hyperlinks do not point directly to the actual documents. Rather, such hyperlinks point to the dynamically generated active search page 60 and a document identifier. When the client user clicks on the hyperlink, the active server page 60 uses the document identifier to extract the identified document from the storage system 22 and to dynamically generate a file containing the identified document that can be accessed by the browser.

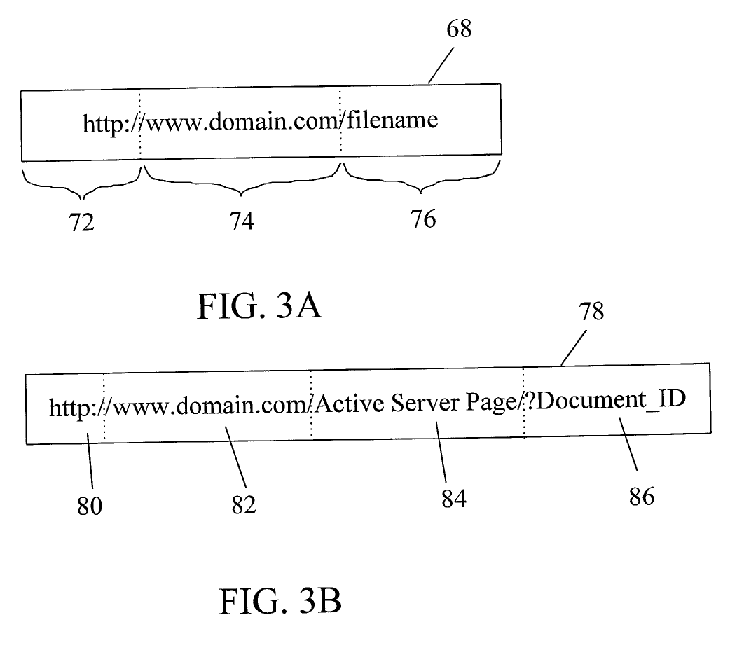

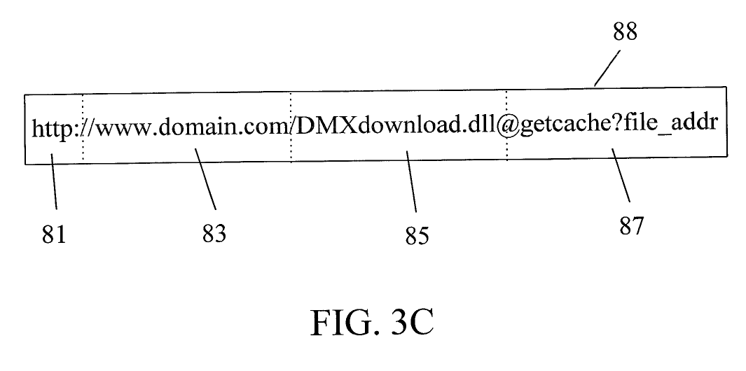

FIG. 3A shows an exemplary conventional hyperlink 68 having protocol information 72, host server information 74, and resource information 76. As shown, the protocol information is “http,” which indicates that the client node 10 is using the HyperText Transfer Protocol to retrieve the resource called “filename.” Typically, the resource information 76 is a name of a document or software program on the server indicated by the host server information 74.

FIG. 3B shows an exemplary hyperlink 78 according to the invention. Like the conventional hyperlink 68, the virtual hyperlink 78 includes protocol information 80 and host server information 82. Hyperlinks 78 can support other protocols than HTTP (e.g., ftp, secure HTTP (https), gopher, telnet, etc.). The hyperlink 78 also includes program information 84 and content identification information 80. The program information 84 references an active server page on the server indicated by the host server information 82. The content identification information 86 includes a document identifier parameter. The active server page 84 uses this parameter to extract a document from the storage system 22, as specified by the document identifier, and then redirects to a second hyperlink 88, described below in FIG. 3C, which sends the contents of the document to the browser via the server 14.

FIG. 3C shows an exemplary hyperlink 88 according to the invention. Like the conventional hyperlink 68 and the virtual hyperlink 78, the hyperlink 88 includes protocol information 81 and host server information 83. The hyperlink 88 also includes program information 85 and parameter information 87. The program information 85 indicates an executable program to be executed on the server identified by the host server information 83. The parameter information 87 can include a command and the address location of the file (i.e., the physical name of the file). The command indicates an action to be performed by the program, and the physical name of the file indicates to the program the address location at which to find the file.

The server 14 redirects execution to this program, passing the parameter information 87 to the program. In this example, the program name is DMXdownload.dll, a modified ISAPI.dll program, the command is “getcache,” which retrieves the contents of the file from the address location, here given by file_addr 87.

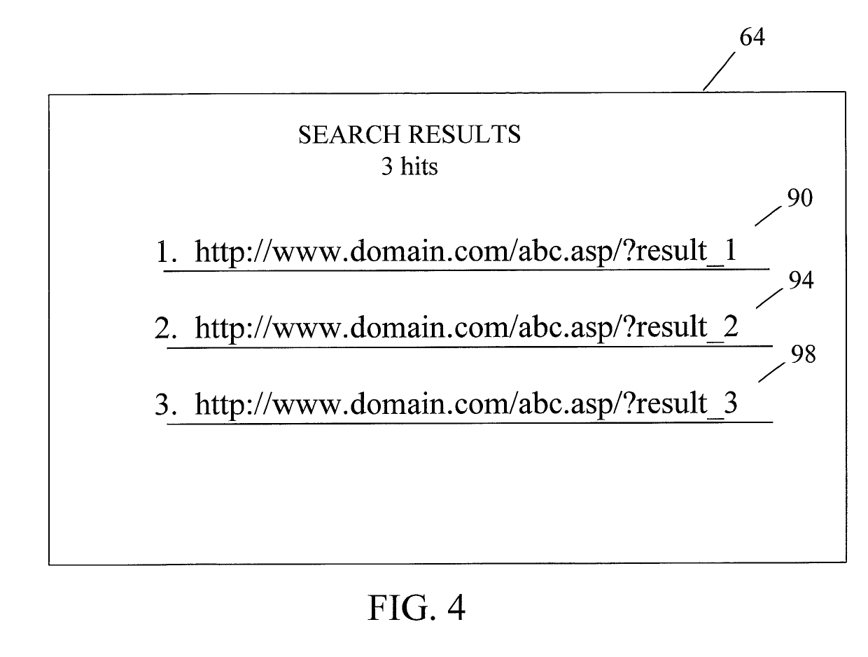

FIG. 4 shows an exemplary HTML search results page 64 including three hyperlinks 90, 94, 98 representing three documents found in the storage system 22 satisfying the specified search parameters. For illustration purposes only, the found documents are called “result_{—}1,” “result_{—}2,” and “result_{—}3.” For each found document, there is a hyperlink. Each of the hyperlinks 90, 94, 98 refers to the same host server “domain,” which in this example is server 14, and exemplary active server page “abc.asp” on that host server. Each hyperlink can also have a “friendly name,” such as the title of the corresponding found document.

The hyperlinks 90, 94, 98 differ from each other in their content identification information, each hyperlink 90, 94, 98 referring to a different document identifier. For example, the hyperlink 90 references the document identifier “result_{—}1,” hyperlink 94 references “result_{—}2,” and hyperlink 98, “result 3.”

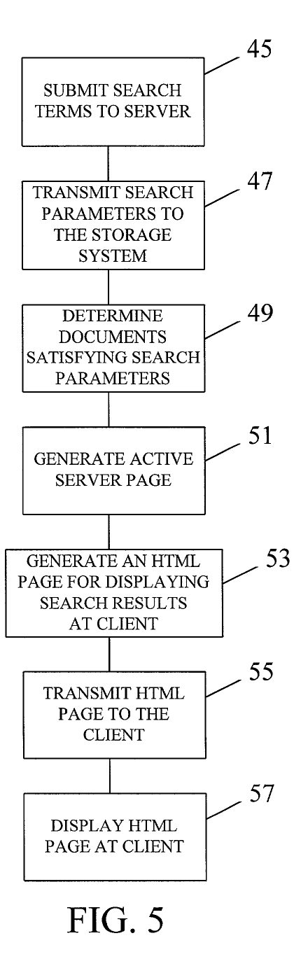

FIG. 5 shows an exemplary process for conducting a query corresponding to the document search described in FIG. 2. In step 45, the user of the client node 10 specifies search terms in the search term box 46 and submits the search terms 48 to the server 14. The server 14, in step 47, performs the document search query according to the specified search terms by sending search parameters corresponding to the search terms and the appropriate objects to the storage system 22. The storage system 22 determines a list of documents that satisfy the search parameters and reports the search results to the server 14 (step 49).

In step 51, the server 14 produces the active server page 60 corresponding to the documents found by the search query 52. The server 14 formats the results into the HTML page 64 including hyperlinks referencing the found documents (step 53), and transmits the HTML page 64 to the client node 10 (step 55). The HTML page 64 is displayed on the client display screen 26 (step 57).

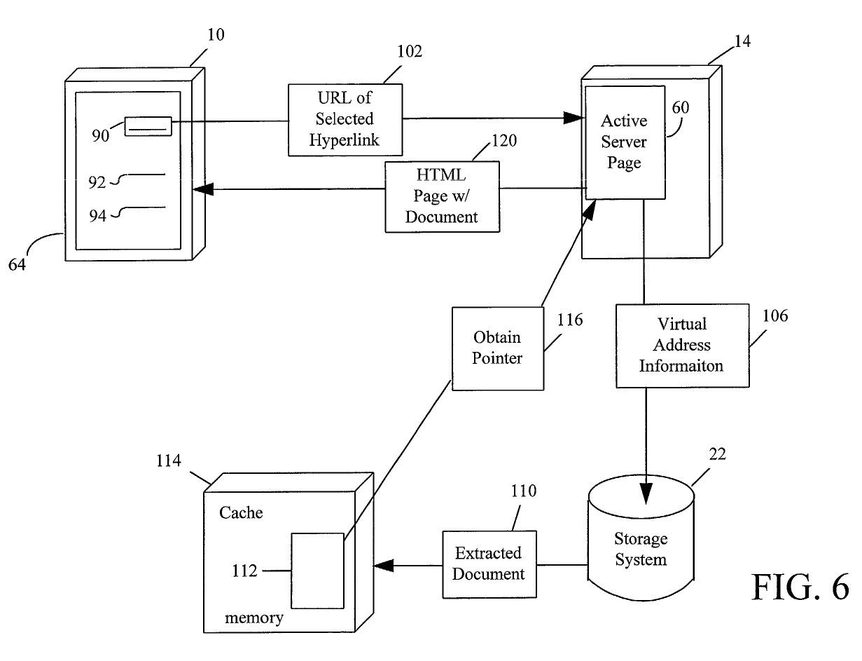

FIG. 6 shows an exemplary communication sequence between the client node 10 and the server 14 for displaying at the client node 10 one of the documents found as a result of the document search described in FIG. 2. The exemplary HTML page 64, with the hyperlinks 90, 94, 98, appears on the display screen 26 of the client node 10. In this example, the user of the client node 10 selects the document “result_” referenced by the hyperlink 90. The user can make the selection by clicking on a hyperlink 90 with the mouse 42. The URL 102 associated with the selected hyperlink 90 references the dynamically generated active server page 60 on the server 14 and navigates to the server 14. For example, the URL 102 can be:

http://www.server_14.com/abc.asp/?result_1,

where the URL 102 references the active server page 60 named “abc.asp” on server 14. The “?” indicates that search parameters follow. Here, the search parameter (i.e., content identification information) includes the document identifier “result_{—}1,” which is understood by the storage system 22 to be a request to extract a document by that name.

Navigation to the server 14 starts the active server page 60 program (e.g., abc.asp), which communicates with the storage system 22 to obtain the document identified in the URL 102. The active server page 60 uses the content identification information of the URL 102, which includes the document identifier result_{—}1, to create a document object corresponding to the document identifier. The storage system 22 extracts a copy of the identified document as instructed by the content identification information and stores the extracted copy 110 in a file 112 in memory 114. The memory 114 can be temporary or persistent and can be located on the server 14, the storage system 22, or in another computer system (not shown). In reply to a request from the active server page 60, the storage system 22 returns a pointer 116 to the address location where the file 112 is stored in the memory 114.

A new URL is generated. The new URL points to the address location of the file 112 and a program for reading, HTML formatting, and transmitting to the client node 10 the contents of the file. In one embodiment, this program is a modified version of the standard ISAPI DLL (called ISAPI-extension DLL). The new URL can reference this ISAPI extension DLL and the name of the file 112. For example, the new URL can be:

ISAPI_extension.dll+result_{—}1.

If the file 112 is stored on a server other than server 14, then the new URL can be:

other_server/ISAPI_extension.dll+result_{—}1.

The active server page 60 then redirects processing to the new URL address. The ISAPI extension DLL, for example, produces standard HTML headers, reads the copy of the specified digital information from the file 112 stored in the memory 114, formats the digital information to produce an HTML page 120, and transmits the HTML page 120 over the network 18 to the browser at the client node 10.

Consequently, the client user receives the document that the user requested by selecting the hyperlink 90, but the user received that document from a different URL than the one indicated by that hyperlink 90. Herein a part of the virtual behavior of a hyperlink according to the invention can be observed: the selected hyperlink 90 specified one URL (e.g., http://www.server_{—}14.com/abc.asp/?result_{—}1), and the server 14 returned the file from a second, different URL (e.g., http://other_server/ISAPI_extension.dll?result_{—}1). Although the browser may display this second URL to the client user, this second URL represents just a temporary storage of the copy of the document contents, and may give the client user no indication of where the original version of the document resides (i.e., the storage system 22).

Conceivably, a user of the Intranet 24 can modify the original version of the document, in this example result_{—}1, in the storage system 22 after a copy of the document has been extracted and returned to the client node 10. A subsequent selection by the client user of the hyperlink 90 can obtain the modified document from the storage system 22 as previously described.

While the invention has been shown and described with reference to specific preferred embodiments, it should be understood by those skilled in the art that various changes in form and detail may be made therein without departing from the spirit and scope of the invention as defined by the following claims.

We claim:

1. A method for providing content to a user via a network, comprising the steps of:
receiving from a client node a request to obtain digital information, wherein the request includes a first resource locator specifying the digital information to be obtained;
dynamically generating a file containing a copy of the specified digital information in response to the first resource locator;
storing the file at an address location in memory; and
accessing the file at the address location with a second resource locator different from the first resource locator to obtain the specified digital information for transmission over the network to the client node.

2. The method of claim 1 wherein the file is stored at a computer system other than at the server system.

3. The method of claim 1 wherein the first resource locator leads to a document containing content that can change dynamically.

4. The method of claim 1 further comprising the steps of:
maintaining an executable program that communicates with a storage system in response to the first resource locator.

5. The method of claim 4 further comprising the step of obtaining the copy of the specified digital information from the storage system.

6. The method of claim 4 wherein the executable program is dynamically generated in response to a query to find digital information according to one or more search terms specified by a user of the client node.

7. The method of claim 4 further comprising the steps of:
receiving a query to find documents according to one or more search terms specified by a user of the client node; and
dynamically generating a page containing results of the query, the page including at least one hyperlink, each hyperlink being associated with a document found according to the specified search terms and pointing to the executable program.

8. The method of claim 1 wherein the first resource locator includes a document identifier and further comprising the steps of:
transmitting the document identifier to the storage system; and
extracting the specified digital information from the storage system in response to the document identifier.

9. The method of claim 1 further comprising the step of generating the second resource locator using a name of the file and a name of a program on the server system that, when executed, reads the file and transmits contents of the file to the client node.

10. A method for providing content to a user via a network, comprising the steps of:
at a server system, receiving from a client node a request to obtain digital information wherein the request includes a first resource locator having address information specifying digital information to obtain from a storage system;
executing a program on the server system in response to the first resource locator wherein the executing includes the steps of:
extracting a copy of the specified digital information from the storage system;
dynamically generating a file containing the copy of the specified digital information;
storing the file at an address location in memory; and
generating a second resource locator different from the first resource locator, the second resource locator pointing to the address location; and
accessing the file at the address location using the second resource locator to obtain the specified digital information for transmission over the network to the client node.

11. The method of claim 10 further comprising the steps of:
navigating to a Web page containing a form for entering search terms for conducting a search;
receiving the search terms at the server system;
querying the storage system using query objects designed specifically for querying the storage system according to the received search terms;
dynamically generating the program on the server in response to the search query; and
formatting results of the search query into an HTML page containing a list of found documents and a hyperlink corresponding to each found document, each hyperlink pointing to the program on the server system and including an identifier for the found document corresponding to that hyperlink.

12. A hyperlink notation for obtaining content via a network, comprising:
a first resource locator comprising:
protocol information;
server information indicating an address of a server located on the network;
content identification information specifying digital information to be obtained from a storage system; and
program information indicating an executable program located on the server,
wherein the program, when executed, communicates with the storage system to dynamically generate a file containing a copy of the specified digital information and to store the file at an address location in memory having a second resource locator different from the first resource locator.

13. The hyperlink notation of claim 12 wherein the content identification information includes a document identifier specifying the digital information to be obtained from the storage system and an object for extracting the identified document from the storage system.

14. The hyperlink notation of claim 12 wherein the content identification information follows the program information.

15. A system for delivering content to a user via a network, comprising:
a server system receiving from a client node a request to obtain digital information, wherein the request includes a first resource locator specifying the digital information to be obtained from a storage system;
a file dynamically generated in response to the first resource locator and containing a copy of the specified digital information; and
memory storing the file at an address location, wherein the server system accesses the file at the address location with a second resource locator different from the first resource locator to obtain the specified digital information for transmission over the network to the client node.

16. The system of claim 15 further comprising a computer system in communication with the server system, and wherein the file is stored at the system.

17. The system of claim 15 further comprising:
an executable program on the server system that communicates with the storage system in response to the first resource locator.

18. The system of claim 17 wherein the executable program is dynamically generated in response to a query to find digital information according to one or more search terms specified by the user of the client node.

19. The system of claim 17 further comprising a dynamically generated page containing results of a query to find documents according to one or more search terms specified by a user of the client node, the page including at least one hyperlink, each hyperlink being associated with a document found according to the specified search terms and pointing to the executable program at the server system.

20. The system of claim 15 further including the storage system in communication with the server system.

21. The system of claim 20 wherein the storage system is unconnected to the network except through the server system.

22. The system of claim 15 wherein the storage system includes a document management system.
